(19) United States
(12) Patent Application Publication
(10) Pub. No.: US 2006/0076456 A1
(43) Pub. Date: Apr. 13, 2006

(54) Thrust/airflow control device

(76) Inventor: Otis Franklin Layton, Bonney Lake, WA (US)

Correspondence Address: Otis Layton, P.O. Box 7442, Bonney Lake, WA, 98391, US

(21) Appl. No.: 11/245,707

(22) Filed: Oct. 7, 2005

Related U.S. Application Data
(60) Provisional application No. 60/616,813, filed on Oct. 7, 2004.
(60) Provisional application No. 60/618,810, filed on Oct. 14, 2004.
(60) Provisional application No. 60/616,812, filed on Oct. 7, 2004.

(51) Int. Cl. B64D 33/02

(52) U.S. Cl. 244/53 B

(57) ABSTRACT

A device used in a ducted fan (shrouded propeller or similar axial flow, air moving producer) that's positioned on or about the ducted fan so as to disrupt or distort the subsequent laminar airflow induced by said air moving producer. The said device would, when actuated rapidly and precisely increase or decrease proportionately the resultant net thrust/airflow without varying the fan/propellers RPM.

This non-provisional utility patent application claims the benefit of provisional patent No. 60/616,813 filed on Oct. 7, 2004, provisional patent No. 60/616,810 filed on Oct. 7, 2004 and provisional patent No. 60/616,812 filed on Oct. 7, 2004.

### BACKGROUND OF INVENTION

Throughout history designers and engineers have worked tirelessly to optimize axial flow devices (including ducted fans). The results have yielded impressive net thrust gains and very high efficiencies. Control of this thrust is typically controlled by varying the fans RPM or by the use of a large thrust reverser type deflectors. Although this type of control system might function adequately in some applications, other situations require precise and rapid thrust response inputs. It is the principle object of this invention to provide a shrouded axial flow device a method of precisely and rapidly controlling net thrust with a simple, lightly loaded device.

### DETAILED DESCRIPTION OF THE PREFERRED EMBODIMENT

Referring to FIG. 1 through 4—the thrust generated through the ducted fan structure is increased due to the aerodynamic laminar air flow features of the inlet lip/bellmouth (detail 5) and the close tolerance between the fan blades (details 2, 8) and the duct inlet wall (detail 3).

FIG. 1 depicts a ducted fan unit with its “spoilers” (detail1) in the deployed position, disrupting the laminar air flow over the said inlet duct/bellmouth (detail 5), effectively reducing the net thrust produced by the said ducted fan unit.

FIG. 2 depicts the same ducted fan with the said “spoiler” in its retracted position (detail 4), allowing an efficient, undisturbed laminar airflow over the inlet lip/bellmouth (detail 5) effectively increasing the net thrust of the ducted fan unit.

In another embodiment, FIGS. 3 and 4 depict a ducted fan unit with articulated (opening and closing) slots or openings in the open position FIG. 3 (detail 6). The said slots or openings create a laminar air flow distortion/disturbance, their by effectively decreasing the said ducted fans net thrust output.

In FIG. 4 the said slots or openings (detail 7) are closed, thus allowing undistorted/undisturbed laminar air flow to be maintained, effectively creating a measurably increase in net thrust output.

FIGS. 5 and 6 depict, in yet another embodiment, a fan or propeller that utilizes alternating blades (detail 8) that are pitch moveable/adjustable.

FIG. 5 depicts a fan/propeller with its pitch moveable blades (detail 8) in a full positive pitch position (the same pitch position as the stationary blades depicted in detail 2)), creating maximum measurable thrust at a given RPM.

In FIG. 6 the said fan/propeller's moveable blades (detail 8) are in a full negative pitch position, thus reducing thrust at the same given RPM.

Each of these embodiments utilizes various methods to produce similar effects (gains and losses) on the net thrust on an axial flow thrust producing device. Although a ducted fan unit was depicted in these embodiments, it is in no way intended to limit or restrict, in whole or in part, its intended application to precisely control the thrust output of various air moving devices.

### BRIEF DESCRIPTION OF THE DRAWINGS

FIG. 1 depicts a ducted fan with a retractable “spoiler” structure in an extended position.

FIG. 2 depicts a ducted fan with the “spoiler” structure in the retracted position

FIG. 3 depicts a ducted fan with articulated/closeable openings or slots in the inner duct wall, circumferentially positioned relative to the fans plane.

FIG. 4 depicts a cut-away view ducted fan with the opening or slots in a near-closed position.

FIG. 5 depicts a fan or propeller with pitch moveable, alternate blades in a full positive pitch position.

FIG. 6 depicts a fan or propeller with pitch moveable, alternate blades in a full negative pitch position.

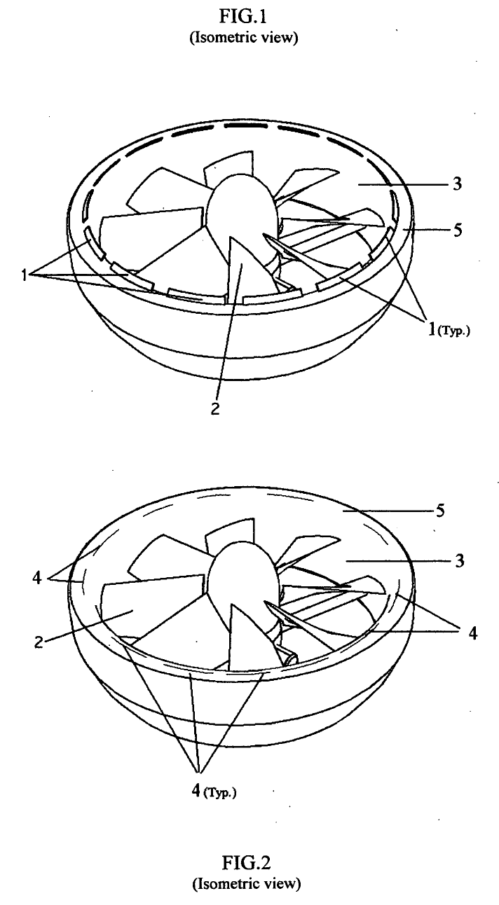

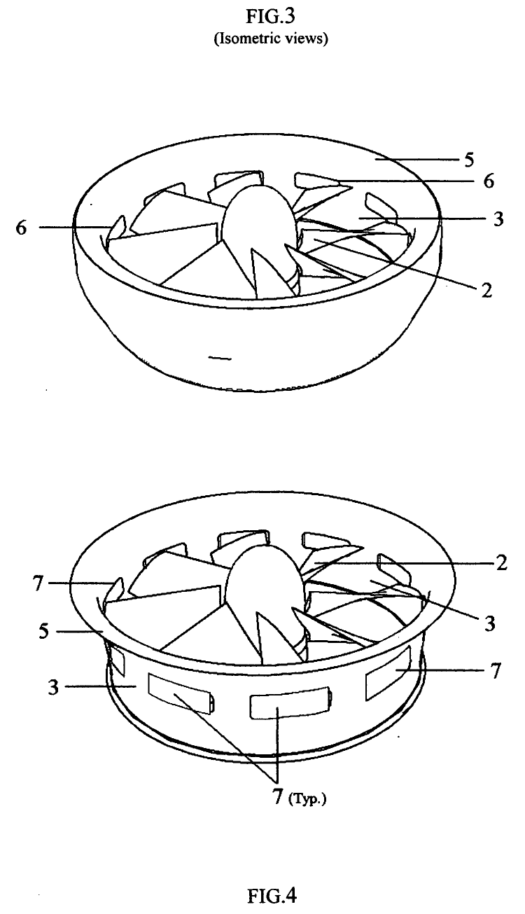

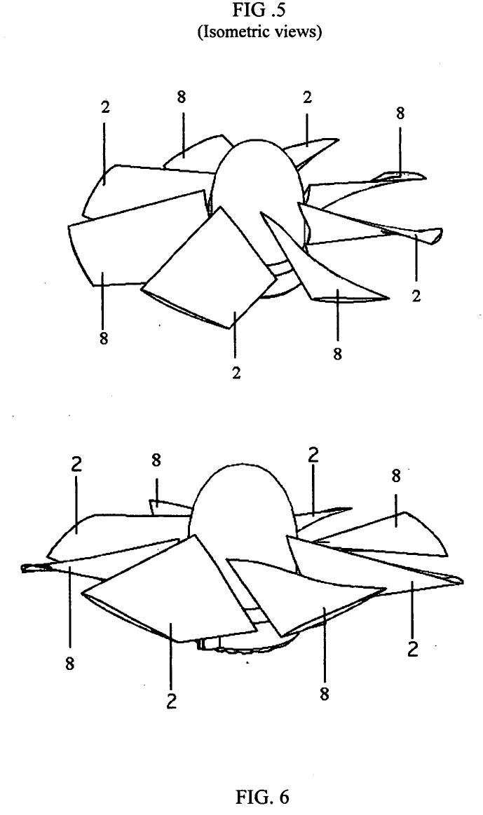

What is claimed is:

1. A retractable structure positioned on or about the inlet lip, also known as the bellmouth of a duct or turbo fan (or any shrouded or ducted air moving device), so as when in the open position disturbs the laminar air flow entering the said duct, therefore reducing net thrust production.

2. A retractable structure according to claim 1, that when in a “closed” position allows unrestricted airflow into said duct there by returning net thrust production to it's pre-restricted state.

3. A retractable structure according to claim 2, that include a method of rapidly opening and closing the said structure to varying positions relative to said inlet lip or bellmouth structures, to allow to a varying degree, the reduction of said thrust.

4. A moveable surface positioned on the interior wall of a ducted fan's duct at or near the position of the fan's circumferential rotary plane, that when in an open position creates a laminar air flow distortion, resulting in an immediate and precisely controllable net loss of thrust.

5. A moveable surface according to claim 4, that when in a closed position allows unrestricted and unaltered laminar air flow through the said duct.

6. A moveable surface according to claim 5, that includes a method of rapidly opening and closing said surfaces, vents or slats, to varying positions so as to allow precisely controlled net thrust variations.

7. A moveable surface according to claim 6 that may also redirect some or all of the said vented thrust in a directed manner so as to accomplish a semi-vectored or reverse thrusting action.

8. A rotary fan system that includes a number of multiple blades of 4 or greater.

9. A rotary fan system according to claim 8, in which every other said blade is controllable in pitch movement.

10. A rotary fan system according to claim 9, in which every other said blade is fixed in pitch movement.

11. A rotary fan system according to claim 9, that includes a method of precisely controlling said blades to varying positive and negative degrees of pitch.
